(19) United States
(12) Patent Application Publication
(10) Pub. No.: US 2012/0155308 A1
(43) Pub. Date: Jun. 21, 2012

(54) METHOD FOR CONTROLLING ACCESS POINT AND APPARATUS FOR THE SAME IN COMMUNICATION SYSTEM

(75) Inventors: Je-Hun LEE, Daejeon (KR); Sok-Kyu Lee, Daejeon (KR)

(73) Assignee: Electronics and Telecomcunications Research Institute, Daejeon (KR)

(21) Appl. No.: 13/330,572

(22) Filed: Dec. 19, 2011

(30) Foreign Application Priority Data
Dec. 21, 2010 (KR) 10-2010-0131685
Oct. 20, 2011 (KR) 10-2011-0107718

(51) Int. Cl. H04W 24/00; H04L 12/26

(52) U.S. Cl. 370/252

(57) ABSTRACT

Disclosed is a method for controlling a plurality of access points by a monitoring station in a communication system, including: receiving access point status report policy information from a control server; receiving a basic service set load information element from the plurality of access points; generating access point status information by using the basic service set load information element; transmitting the access point status information to the control server by a method specified in the access point status report policy information; receiving an access point control command from the control server; and transmitting the access point control command to the plurality of access points.

### CROSS-REFERENCES TO RELATED APPLICATIONS

The present application claims priority of Korean Patent Application Nos. 10-2010-0131685 and 10-2011-0107718, filed on Dec. 21, 2010 and Oct. 20, 2011, respectively, which are incorporated herein by reference in their entireties.

### BACKGROUND OF THE INVENTION

1. Field of the Invention

Exemplary embodiments of the present invention relate to an access point, and more particularly, to a method and an apparatus for controlling a plurality of access points located in a specific zone in a communication system.

2. Description of Related Art

Recently, as a portable terminal in which a wireless communication system function is embedded is widely distributed, a plurality of access points have been widely disposed so as to extend a wireless network. The portable terminals access a plurality of access points while moving among the access points. In this case, there is a need to efficiently control channels, power, or the like, required for the portable terminals and the plurality of access points to transmit and receive information so as to rapidly provide wireless network services with good quality.

However, in accordance with the related art, a technology for controlling loads between a plurality of access points is really insufficient. Therefore, a need exists for a technology for controlling a plurality of access points within a specific zone while using the existing standards as they are.

### SUMMARY OF THE INVENTION

An embodiment of the present invention is directed to provide more rapidly wireless network services with improved quality by efficiently controlling a plurality of access points in a communication system.

Further, another embodiment of the present invention is directed to provide a method and an apparatus for controlling a plurality of access points in a communication system while using the existing standards as they are, without modifying the standards.

The objects of the present invention are not limited to the above-mentioned objects and therefore, other objects and advantages of the present invention that are not mentioned may be understood by the following description and will be more obviously understood by exemplary embodiments of the present invention. In addition, it can be easily appreciated that objects and advantages of the present invention may be implemented by means and a combination thereof described in claims.

In accordance with an embodiment of the present invention, a method for controlling a plurality of access points by a monitoring station in a communication system includes: receiving access point status report policy information from a control server; receiving a basic service set load information element from the plurality of access points; generating access point status information by using the basic service set load information element; transmitting the access point status information to the control server by a method specified in the access point status report policy information; receiving an access point control command from the control server; and transmitting the access point control command to the plurality of access points.

In accordance with another embodiment of the present invention, a method for controlling a plurality of access points by a control server in a communication system includes: transmitting access point status report policy information to a monitoring station; receiving access point status information transmitted by a method specified in the access point status report policy information from the monitoring station; generating an access point control command by using the access point status information and the access point control policy information; and transmitting the access point control command to the monitoring station.

In accordance with another embodiment of the present invention, an apparatus for controlling a plurality of access points in a communication system includes: a receiver configured to receive access point status report policy information and an access point control command from a control server and a basic service set load information element from the plurality of access points; a generator configured to generate access point status information by using the basic service set load information element; and a transmitter configured to transmit the access point status information by a method specified in the access point status report policy information to the control server and transmit the access point control command to the plurality of access points.

In accordance with an embodiment of the present invention, an apparatus for controlling a plurality of access points in a communication system includes: a transmitter configured to transmit access point status report policy information and access point control command to a monitoring station; a receiver configured to receive access point status information transmitted by a method specified in the access point status report policy information from the monitoring station; and a generator configured to generate the access point control command by using the access point status information and access point control policy information.

### BRIEF DESCRIPTION OF THE DRAWINGS

FIG. 1 is a configuration diagram illustrating an apparatus for controlling an access point in a communication system in accordance with an embodiment of the present invention.

FIG. 2 is a signal transmitting and receiving flow chart for describing a method for controlling an access point in a communication system in accordance with the embodiment of the present invention.

FIG. 3 is a diagram for describing a method for controlling an access point channel in a communication system in accordance with the embodiment of the present invention.

FIG. 4 is a diagram for describing a method for controlling an access point channel in a communication system in accordance with another embodiment of the present invention.

FIG. 5 is a diagram for describing a method for controlling access point power in a communication system in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

As a portable terminal in which a wireless communication system function in accordance with embodiments of the present invention is embedded is widely distributed, a plurality of access points have been widely disposed so as to extend a wireless network. The portable terminals access a plurality of access points while moving among the access points. In this case, the embodiments of the present invention perform efficiently control channels, power, or the like, required for the portable terminals and the plurality of access points to transmit and receive information so as to rapidly provide wireless network services with good quality.

For example, a method for managing only one specific access point or a method for controlling a plurality of access points by modifying the existing standards has been proposed. Further, the existing IEEE 802.11 or Wi-Fi Alliance (WFA) based standards define some of standards for maintaining and managing access points. Therefore, the embodiments of the present invention provide a technology for controlling a plurality of access points within a specific zone while using the existing standards as they are.

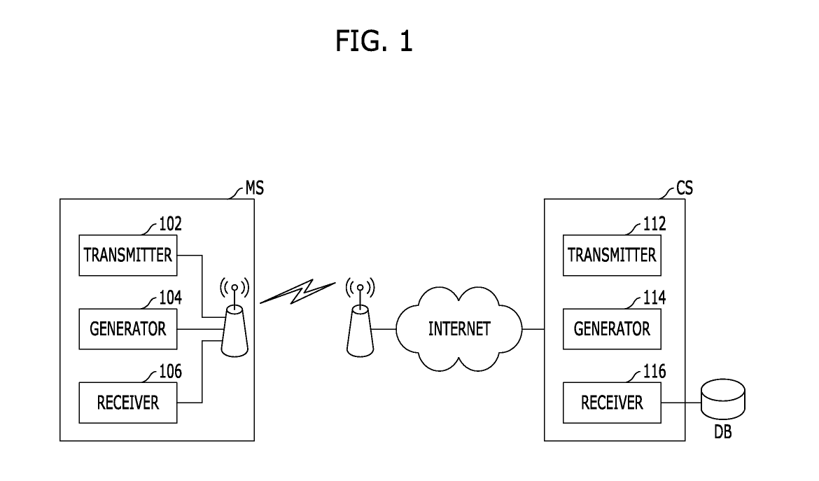

FIG. 1 is a configuration diagram illustrating an apparatus for controlling an access point in a communication system in accordance with an embodiment of the present invention.

Referring to FIG. 1, a monitoring station (MS) may be configured to include a transmitter 102, a generator 104, and a receiver 106.

The transmitter 102 may transmit access point status information by a method specified in access point status report policy information to a control server (CS). In addition, the transmitter 102 may transmit an access point control command to a plurality of access points.

In this case, the access point control command may include a channel command, a power command, group channel/power control service authentication information, or the like, regarding the plurality of access points, but are not limited thereto.

Further, the transmitter 102 may transmit the access point control command to the plurality of access points by using a probe request frame, a vendor specific action frame, or the like, but is not limited thereto.

Meanwhile, the transmitter 102 further transmits station status information regarding stations accessing the plurality of access points to the control server (CS). In this case, the station status information may include quality of service support information, power save status information, channel operation support information, or the like, but is not limited thereto.

The generator 104 may generate the access point status information by using basic service set load information elements.

The receiver 106 may receive the access point status report policy information and the access point control command from the control server (CS). Further, the receiver may receive the basic service set load information elements from the plurality of access points.

As illustrated in FIG. 1, the control server CS may be configured to include a transmitter 112, a generator 114, and a receiver 116.

The transmitter 112 may transmit the access point status report policy information and the access point control command to the monitoring station (MS).

The generator 114 may generate the access point control command by using the access point status information and the access point control policy information.

The receiver 116 may receive the access point status information transmitted by a method specified in the access point status report policy information from the monitoring station (MS).

As such, the control server (CS) including the transmitter 112, the generator 114, and the receiver 116 may be used as a node that performs control determination based on the access points or the station status information received from the monitoring station (MS) according to the access point control policy information.

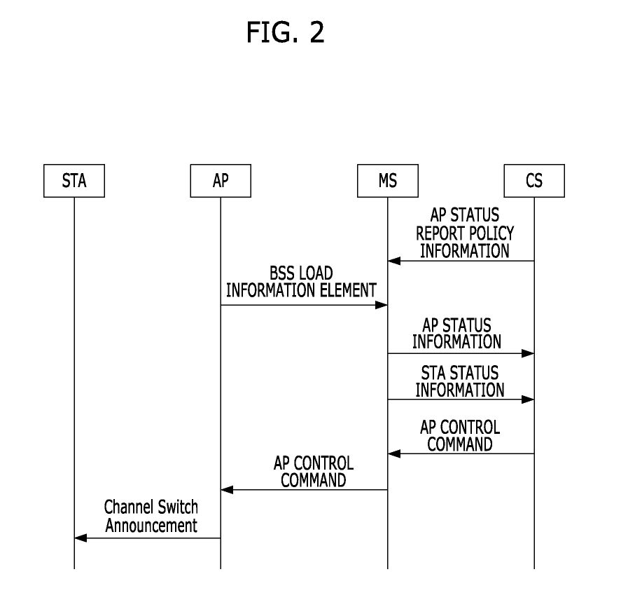

FIG. 2 is a signal transmitting and receiving flow chart for describing a method for controlling an access point in a communication system in accordance with the embodiment of the present invention.

As illustrated in FIG. 2, the access point (AP), which is an apparatus for accessing stations (STA) within a predetermined region to a wireless network, may control an access point (AP) so as to change an access channel of the station (STA) in the embodiment of the present invention.

Referring to FIG. 2, the control server (CS) may transmit the access point (AP) status report policy information to and from the monitoring station (MS). The access point (AP) status report policy information may include the information regarding a method for reporting the status of the access point (AP) determined by the monitoring station (MS) to the control server (CS). In this configuration, the status of the access point (AP) may include, for example, an access point service set identifier (SSID), a timestamp, the basic service set load information elements, the station (STA) status information, or the like. Meanwhile, according to the access point (AP) status report policy information, the monitoring station (MS) periodically reports the status of the access point (AP) to the control server (CS) according to a predetermined schedule or a predetermined threshold, but is not limited thereto.

The monitoring station (MS) may receive the basic service set load information elements from the plurality of access points (APs). The basic service set load information elements may include the use information of the number of stations (STAs) or the channels, or the like, that access the corresponding basic service set. The plurality of access points (APs) may transmit the basic service set (BSS) load information elements to the monitoring station (MS) by using a beacon frame.

The monitoring station (MS) may generate the access point (AP) status information by using the basic service set load information elements received from the plurality of access points (AP). The monitoring station (MS) may store each of the received basic service set load information elements for each access point (AP) and generate the access point (AP) status information using the received basic service set load information elements.

The monitoring station (MS) may transmit the access point (AP) status information to the control server (CS) by the method specified in the access point (AP) status report policy information. In this case, the monitoring station (MS) may transmit both of the access point (AP) status information and the station (STA) status information accessing the plurality of access points (APs) to the control server (CS). This is to perform a control according to the characteristics of the station (STA) accessing the access point (AP) while simply controlling the channel or the power. The station (STA) status information may include the quality of service support information, the power save status information, the channel operation (20/40 MHz operation) support information, or the like.

The control server (CS) may generate the access point (AP) control commands by using the access point (AP) status information and the access point (AP) control policy information that are received from the monitoring station (MS) The access point (AP) control policy information is a reference to control the plurality of access points (APs). The access point (AP) is stored in a separate database (DB) and may then be received in the control server (CS). In this case, the access point (AP) control commands may include the channel command, the power command, the group channel/power control service authentication information, or the like, regarding the plurality of access points (APs).

The control server (CS) may transmit the access point (AP) control commands to the monitoring station (MS) and the monitoring station (MS) may transmit the received access point (AP) control commands to the plurality of access points (APs) to control the access points (APs). In this case, upon transmitting the access point (AP) control commands, the probe request frame, the vendor specific action frame, or the like, may be used.

The access point (AP) may perform the channel and power control according to the received control commands. For example, a channel switch announcement may be performed so that the station (STA) changes the access channel.

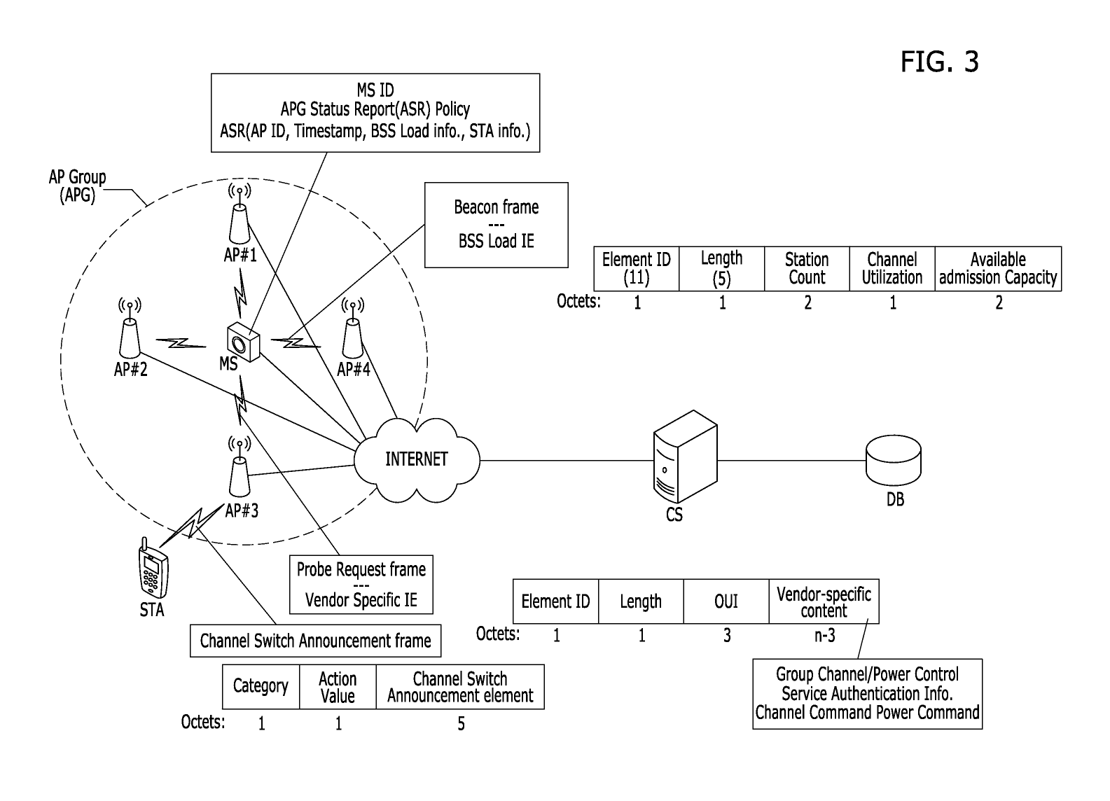

FIG. 3 is a diagram for describing a method for controlling an access point channel in a communication system in accordance with the embodiment of the present invention.

Referring to FIG. 3, the channels of the plurality of access points (APs) may be controlled in the state in which the monitoring station (MS) does not associate with the access points (APs). The plurality of access points (APs) may transmit the beacon frame including the basic service set load information element (BSS load IE) to the monitoring station (MS). The monitoring station (MS) may transmit the access point (AP) status information to the control server (CS) and the control server (CS) may transmit the access point (AP) control commands to the monitoring station (MS) according to the access point (AP) control policy information. In this case, the control command may include the channel command, the power command, the group channel/power control service authentication information, or the like. The monitoring station (MS) may transmit the control commands to the access points (APs) by using the vendor specific IE among the field of the probe request frame. The access point (AP) may transmit a channel switch announcement frame to the station according to the control commands. In this case, there is no separate association process at the time of transmitting and receiving the control commands between the monitoring station (MS) and the access point (AP). Therefore, the control commands may be more rapidly transmitted to the access points (AP) and the memory resources of the access point (AP) may be saved.

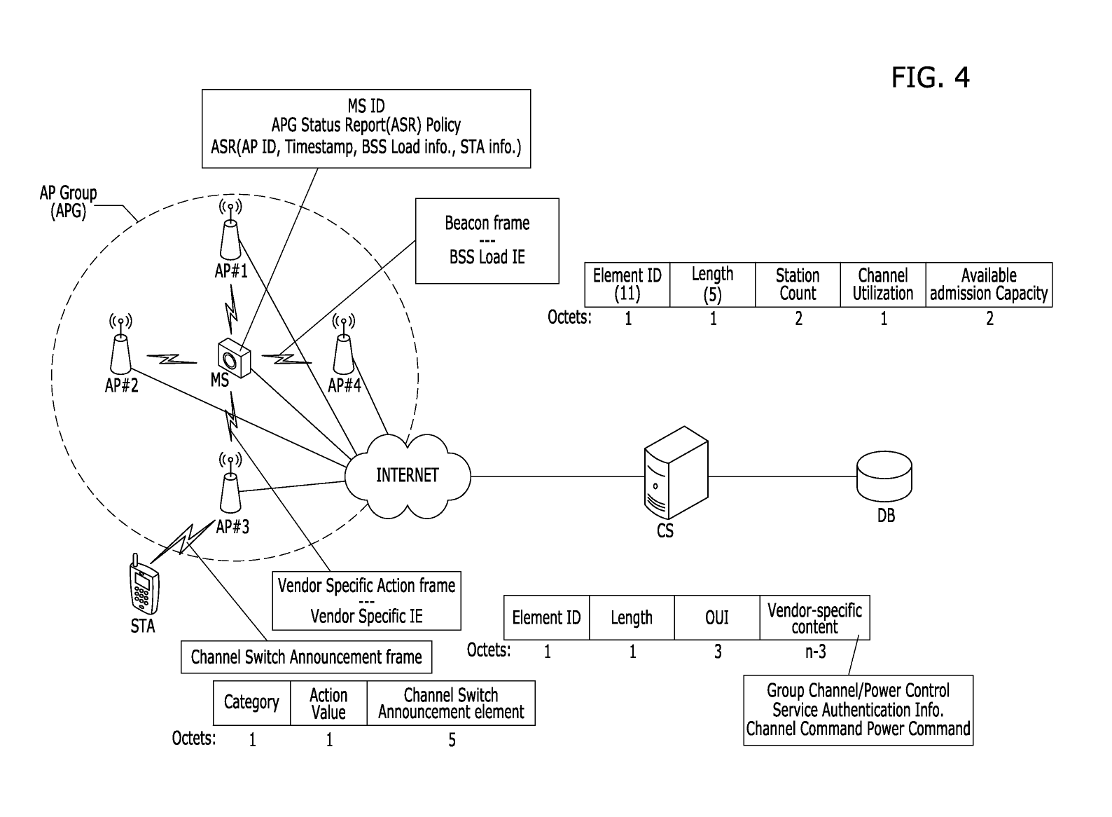

FIG. 4 is a diagram for describing a method for controlling an access point channel in a communication system in accordance with another embodiment of the present invention.

Referring to FIG. 4, the channels of the plurality of access points (APs) may be controlled in the state in which the monitoring station (MS) associates with the access points (APs). The plurality of access points (APs) may transmit the beacon frame including the basic service set load information element to the monitoring station (MS). The monitoring station (MS) may transmit the access point (AP) status information to the control server (CS) and the control server (CS) may transmit the access point (AP) control commands to the monitoring station (MS) according to the access point (AP) control policy information. In this case, the control commands may include the channel command, the power command, the group channel/power control service authentication information, or the like. The monitoring station (MS) may transmit the control commands to the access points (AP) by using the vendor specific information of the vendor specific action frame. The access point (AP) may transmit the channel switch announcement frame to the station (STA) according to the control commands, thereby performing the control commands. In this case, this needs to access each access point (AP) prior to transmitting the control commands, which results in complication; however, more safely transmits the control commands and therefore, may reinforce security.

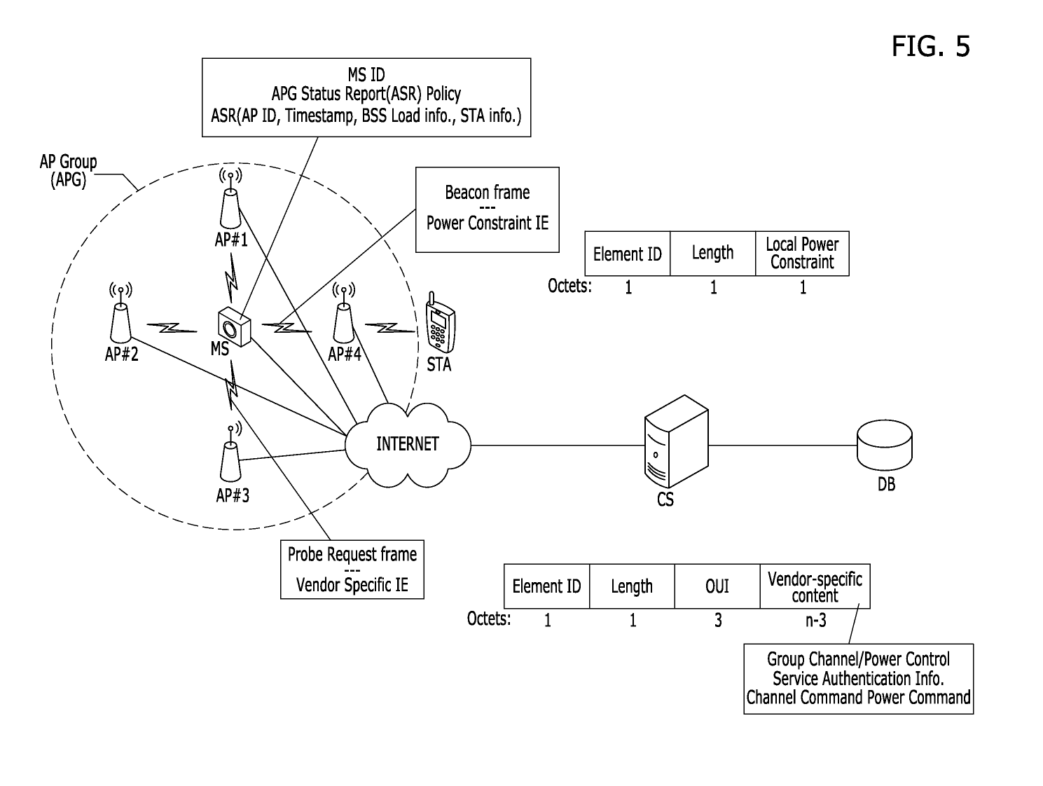

FIG. 5 is a diagram for describing a method for controlling access point power in a communication system in accordance with an embodiment of the present invention.

Referring to FIG. 5, the monitoring station (MS) may control power of the plurality of access points (APs). The plurality of access points (APs) may transmit the beacon frame including the power constraint IE to the monitoring station (MS). The monitoring station (MS) may transmit the access point (AP) status information to the control server (CS) and the control server (CS) may transmit the access point (AP) control commands to the monitoring station (MS) according to the access point (AP) control policy information. In this case, the control commands may include the channel command, the power command, the group channel/power control service authentication information, or the like. The monitoring station (MS) may transmit the control commands to the access points (APs) by using the vendor specific IE among the field of the probe request frame. Although not shown in the drawings, the access point (AP) may confirm the group channel/power control service authentication information and may transmit the power command to the station by using the power constraint IE of the beacon frame. In this case, when the access point (AP) immediately transmits the power constraint IE to the station by the power command and reflects the transmitted power constraint IE, the reassociation frame may be used. Although not shown in the drawings, as another embodiment, when the monitoring station (MS) transmits the control commands to the access points (APs) as in another embodiment, the power command may be performed by using the vendor specific IE of the vendor specific action frame.

As set forth above, the exemplary embodiments of the present invention can more rapidly provide the wireless network services with the improved quality by efficiently controlling the plurality of access points in the communication system.

Further, the exemplary embodiments of the present invention can control the plurality of access points while using the existing standards as they are, without modifying the existing standards.

While the present invention has been described with respect to the specific embodiments, it will be apparent to those skilled in the art that various changes and modifications may be made without departing from the spirit and scope of the invention as defined in the following claims.

What is claimed is:

1. A method for controlling a plurality of access points by a monitoring station in a communication system, comprising:
receiving access point status report policy information from a control server;
receiving a basic service set load information element from the plurality of access points;
generating access point status information by using the basic service set load information element;
transmitting the access point status information to the control server by a method specified in the access point status report policy information;
receiving an access point control command from the control server; and
transmitting the access point control command to the plurality of access points.

2. The method of claim 1, wherein the access point control command includes at least one of a channel command, a power command, and group channel/power control service authentication information regarding the plurality of access points.

3. The method of claim 1, wherein the transmitting of the access point control command to the plurality of access points transmits the access point control command by using at least one of a probe request frame and a vendor specific action frame.

4. The method of claim 1, further comprising transmitting station status information regarding a station accessing the plurality of access points to the control server,
wherein the station status information includes at least one of quality of service support information, power save status information, and channel operation support information.

5. A method for controlling a plurality of access points by a control server in a communication system, comprising:
transmitting access point status report policy information to a monitoring station;
receiving access point status information transmitted by a method specified in the access point status report policy information from the monitoring station;
generating an access point control command by using the access point status information and the access point control policy information; and
transmitting the access point control command to the monitoring station.

6. The method of claim 5, wherein the access point control command includes at least one of a channel command, a power command, and group channel/power control service authentication information regarding the plurality of access points.

7. An apparatus for controlling a plurality of access points in a communication system, comprising:
a receiver configured to receive access point status report policy information and an access point control command from a control server and a basic service set load information element from the plurality of access points;
a generator configured to generate access point status information by using the basic service set load information element; and
a transmitter configured to transmit the access point status information by a method specified in the access point status report policy information to the control server and transmit the access point control command to the plurality of access points.

8. The apparatus of claim 7, wherein the access point control command includes at least one of a channel command, a power command, and group channel/power control service authentication information regarding the plurality of access points.

9. The apparatus of claim 7, wherein the transmitter transmits the access point control command to the plurality of access points by using at least one of a probe request frame and a vendor specific action frame.

10. The apparatus of claim 7, wherein the transmitter further transmits station status information regarding a station accessing the plurality of access points to the control server, and
the station status information includes at least one of quality of service support information, power save status information, and channel operation support information.

11. An apparatus for controlling a plurality of access points in a communication system, comprising:
a transmitter configured to transmit access point status report policy information and access point control command to a monitoring station;
a receiver configured to receive access point status information transmitted by a method specified in the access point status report policy information from the monitoring station; and
a generator configured to generate the access point control command by using the access point status information and access point control policy information.

12. The apparatus of claim 11, wherein the access point control command includes at least one of a channel command, a power command, and group channel/power control service authentication information regarding the plurality of access points.
